(19) United States
(12) Patent Application Publication
(10) Pub. No.: US 2025/0130250 A1
(43) Pub. Date: Apr. 24, 2025

(54) ENCODER SPEED MONITORING DEVICE

(71) Applicant: OKUMA Corporation, Niwa-gun (JP)

(72) Inventors: Tatsuru WATANABE, Niwa-gun (JP); Yoshimasa EGI, Niwa-gun (JP)

(21) Appl. No.: 18/921,446

(22) Filed: Oct. 21, 2024

(30) Foreign Application Priority Data
Oct. 24, 2023 (JP) 2023-182433

(51) Int. Cl. G01P 3/481

(52) U.S. Cl. CPC G01P 3/481

(57) ABSTRACT

A rotation speed monitoring device includes a second MCU that outputs a second count value that is counter-cleared by a Z-phase signal. The second MCU includes: a phase counting counter that counts an A-phase signal and a B-phase signal and outputs the counted result as a base count value; a first capture circuit that latches the base count value at a capture period and outputs the latched value as a position count value; a second capture circuit that latches the base count value at an active edge of the Z-phase signal and outputs the latched value as a reference count value; and a second counter calculation unit that calculates the second count value based on the position count value and the reference count value.

### CROSS REFERENCE TO RELATED APPLICATION

The present invention claims priority under 35 U.S.C. § 119 to Japanese Patent Application No. 2023-182433 filed on Oct. 24, 2023, the entire contents of which being incorporated herein by reference.

### TECHNICAL FIELD

This specification discloses a speed monitoring device using an encoder that outputs a signal with a phase difference according to a rotation angle.

### BACKGROUND

Regarding spindles of machine tools, international standards require a speed limit monitoring function. For example, regarding spindles of lathes, ISO23125 requires that speed limit monitoring be realized in safety category 3.

In general, speed detectors used for the spindles of machine tools are classified into types such as a magnetic encoder (hereinafter, simply referred to as “encoder”) that can output, according to the rotation angle, cosine and sine signals having a wave number N per rotation and having a phase difference of 90 degrees. Usually, these signals are referred to as A-phase signals and B-phase signals.

When this encoder is used to perform speed monitoring, it is usual to refer to count values of a phase difference counter that performs quadruple pulse counting based on the phase difference between the A-phase and B-phase signals and use a difference in values between speed monitoring periods. That is, a safety controller performing the speed monitoring samples count values of the phase difference counter for respective monitoring cycles T, and calculates a monitoring speed V, which is defined as V=(P(n)−P(n−1))/(T×4×N) where P(n) represents the current count value and P(n−1) represents the previous count value. Therefore, to ensure accuracy in performing the speed monitoring using the phase difference counter, the single-turn wave number N set for the phase difference counter is required to be equal to an actual single-turn wave number N of the encoder. The sampling of the phase difference counter by the safety controller may be performed, for example, in safety communication in which the reliability of communication data is guaranteed by protocol.

Further, to realize the speed monitoring using this encoder in safety category 3, it is necessary to use two phase difference counters with different elements to compare the speeds respectively calculated (i.e., differences in pulse count) and perform cross monitoring. Further, the encoder is usually accompanied with a marker signal that outputs one pulse per rotation, which is referred to as a Z-phase signal, to identify the position within one rotation. Further, one of the phase difference counters may be a within-single-turn counter that is cleared by the Z-phase signal, and the other may be a multi-turn counter that counts up and down the Z-phase signal.

Further, calculations are performed to obtain a speed based on a phase difference counter using the Z-phase signal and combining the within-single-turn counter and the multi-turn counter, and a speed based on a phase difference counter not using the Z-phase signal. Then, the obtained two kinds of speeds are compared to confirm whether the single-turn wave number of the encoder is correct.

Non-Patent Document 1 discloses an exemplary counter using the Z-phase signal. The counter disclosed in Non-Patent Document 1 is a micro controller unit (hereinafter, referred to as “MCU”) that has a function of clearing the within-single-turn counter at a rising edge of the Z-phase signal and counting up and down the multi-turn counter depending on an immediate count up or down direction of the within-single-turn counter.

Further, Patent Document 1 discloses a method for realizing the counter clear of the within-single-turn counter and the counting up and down of the multi-turn counter based on a logical level of the Z-phase signal, rather than on the edge of the Z-phase signal, and the rising or falling edge of the A-phase signal and B-phase signal.

¥

### CITATION LIST

### Patent Document

Patent Document 1: JP2009-153335 A

### Non Patent Document

Non-Patent Document 1: “32-Bit Microcontroller FM0+ Family Peripheral Manual Timer Part”, Cypress Semiconductor Corporation, Sep. 9, 2020

According to a counter implemented in a general-purpose MCU disclosed in Non-Patent Document 1, when only the Z-phase signal vibrates without being accompanied with changes of the A-phase signal and the B-phase signal, for example, when the Z-phase signal vibrates at an angle where the edge changes, accurately performing the speed monitoring is infeasible, because the multi-turn counter repeatedly counts up or down. For example, as illustrated in FIG. 3, if vibration of less than 1 count continues near the edge of the Z-phase signal after forward rotation, the multi-turn counter will repeatedly count up at each rising edge of the Z-phase signal

Further, when the Z-phase signal has a wide pulse width, an error occurs in the speed monitoring by an amount corresponding to the pulse width count when the direction of rotation is switched. For example, FIG. 4 illustrates an exemplary timing chart of the Z-phase signal being passed after switching from forward rotation to reverse rotation. In the example of FIG. 4, there is a deviation corresponding to 6 counts between a Z-phase rising edge during forward rotation (see (a) in FIG. 4) and a Z-phase rising edge during reverse rotation (see (b) in FIG. 4). Therefore, at a first Z-phase rising edge following the change in the direction of rotation, a deviation corresponding to 6 counts may occur between the phase difference counter that uses the Z-phase signal and the phase difference counter that does not use the Z-phase signal. These factors cause a disagreement in difference in count value with the phase difference counter that does not use the Z-phase signal, and therefore the safety controller may erroneously detect an abnormality in a speed monitoring interface.

In addition, according to the counter circuit described in Patent Document 1, it is possible to use the Z-phase signal to accurately configure the multi-turn counter and the within-single-turn counter. However, such a counter circuit is not installed in a general-purpose MCU. Therefore, in order to employ a general-purpose MCU to realize a counter comparable to that disclosed in Patent Document 1, it is necessary to add a complicated logical circuit outside the MCU, which leads to increased costs and an increase in probability of dangerous failure per hour (PFHD). It is noted that frequencies of the A-phase signal and the B-phase signal may exceed 100 kHz, and it is difficult to simply substitute software processing of the MCU for the processing comparable to that of the counter circuit disclosed in Patent Document 1.

### SUMMARY

A rotation speed monitoring device disclosed in this specification is a rotation speed monitoring device for monitoring the rotation speed of an object and is characterized by including: an encoder that outputs an A-phase signal of N pulses per rotation, a B-phase signal that is 90 degrees out of phase with respect to the A-phase signal, and a Z-phase signal of 1 pulse per rotation; a first unit configured to output a first count value by quadruple phase counting based on the A-phase signal and the B-phase signal; a second unit configured to calculate a second count value consisting of a within-single-turn count value obtained by counter-clearing, from the Z-phase signal, the count value obtained by the quadruple phase counting based on the A-phase signal and the B-phase signal, and a multi-turn count value obtained by counting up or down the Z-phase signal according to the direction of rotation; and a safety controller that calculates a first monitoring speed based on an amount of change in the first count value, calculates a second monitoring speed based on an amount of change in the second count value, and determines whether there is a speed abnormality based on a result of comparison between the first monitoring speed and the second monitoring speed. The second unit includes: a phase counting counter that performs quadruple phase counting of the A-phase signal and the B-phase signal, and outputs the counted result as a base count value; a first capture circuit that latches the base count value at a capture period being a value obtained by dividing a speed monitoring period by a positive integer, and outputs the latched value as a position count value; a second capture circuit that latches the base count value at an active edge of the Z-phase signal and outputs the latched value as a reference count value; and a second counter calculation unit configured to calculate the second count value based on the position count value and the reference count value. The second counter calculation unit calculates a reference count correction value corresponding to a difference between the base count value and the reference count value at a reference position of the Z-phase signal, based on a current value of the reference count value, a previous value of the reference count value, and a previous value of the reference count correction value, calculates a reference count estimation value by adding the reference count correction value to the reference count value, counts up or down the multi-turn count value based on a magnitude relationship between a current value of the position count value, a previous value of the position count value, and the reference count estimation value, and calculates a difference value between the position count value and the reference count estimation value as the within-single-turn count.

According to the technique disclosed in this specification, it is possible to construct a phase difference counter based on the Z-phase signal by using a general-purpose MCU, and it is possible to inexpensively configure speed monitoring that includes confirmation of agreement between a single-turn wave number setting value in speed monitoring and an actual single-turn wave number of the encoder.

### BRIEF DESCRIPTION OF DRAWINGS

Embodiment(s) of the present disclosure will be described based on the following figures, wherein: FIG. 1 is a block diagram illustrating a speed monitoring device,

FIG. 2 is a flowchart illustrating an exemplary calculation method for a multi-turn counter and a single-turn counter,

FIG. 3 is a timing chart illustrating a problem of a conventional multi-turn counter,

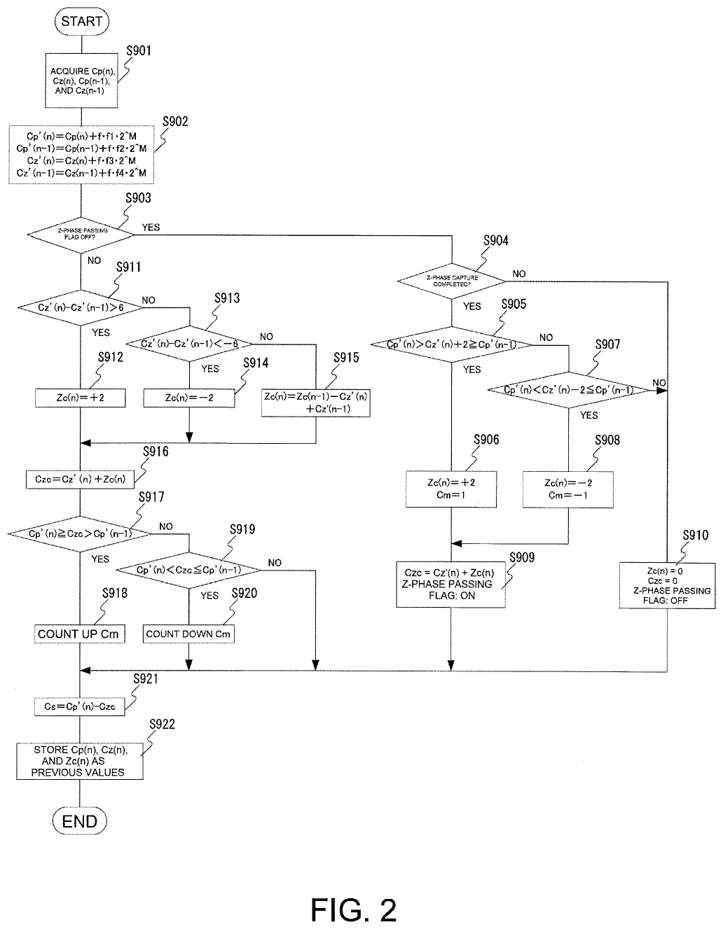

FIG. 4 is a timing chart illustrating a problem of a conventional phase difference counter; and

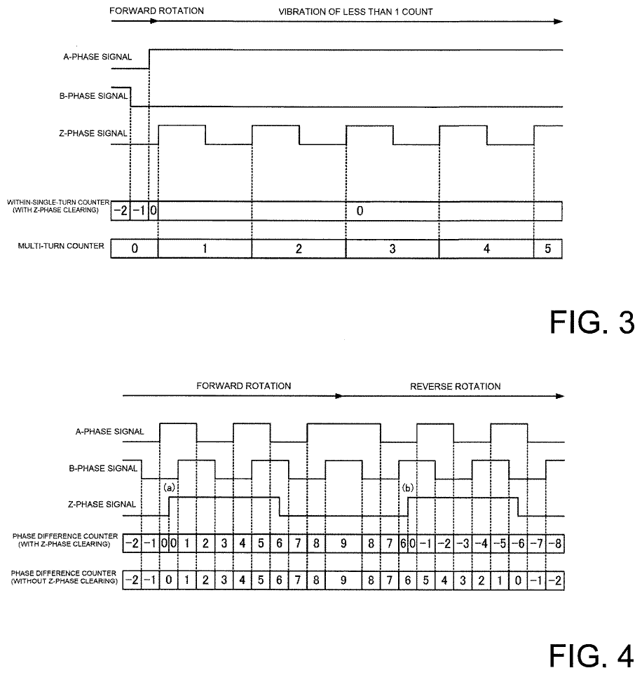

FIG. 5 is a timing chart illustrating counter operations in the speed monitoring device illustrated in FIG. 1.

### DESCRIPTION OF EMBODIMENTS

In the case of duplexing the phase difference counter with different elements, disagreement in change timing may occur between count values due to differences in signal delay time, or the like. Therefore, it is necessary to permit a disagreement in difference between count values of duplexed counters within a range in which the speed monitoring is not adversely affected. When the count method of the phase difference counter is 1×, the permittable disagreement is 1 count or less, which is the minimum resolution, i.e., 1 wave number or less. Even in a case where the count method of the phase difference counter is 4×, if the permittable disagreement is set as a value being comparable in resolution to that in the count method of 1×, the disagreement in difference between count values of 1 wave number or less (i.e., 4 counts or less) in the duplexed counter will be permitted. Therefore, a phase difference counter to be mounted on a general-purpose MCU is configured so as to perform calculations as a phase difference counter combining a multi-turn counter with a single-turn counter, using a Z-phase signal whose error with a phase difference counter that does not use the Z-phase signal due to software processing is less than 4 counts (less than 1 wave number) in difference corresponding to speed monitoring period, based on a position count value sampled at every speed monitoring period and a reference count value sampled at an active edge of the Z-phase signal.

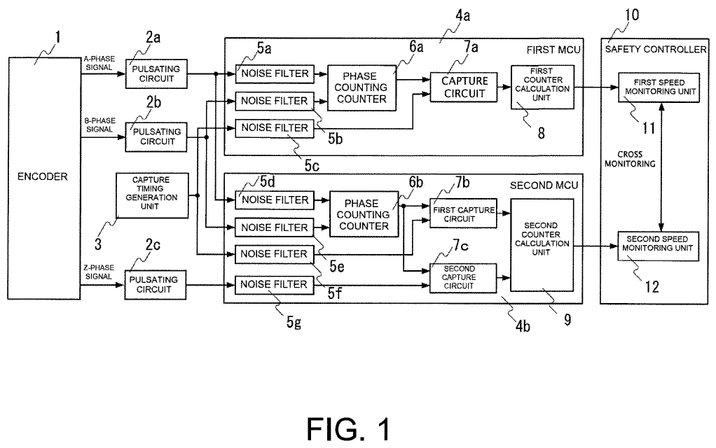

A speed monitoring device will be described with reference to FIGS. 1 and 2. FIG. 1 is a block diagram illustrating an exemplary configuration of the speed monitoring device. FIG. 2 is a flowchart illustrating an exemplary calculation method for a multi-turn counter and a single-turn counter by the speed monitoring device.

An encoder 1 of FIG. 1 outputs, according to the rotation angle of an object (not illustrated), an A-phase signal with wave number N per rotation, a B-phase signal with a phase difference of 90 degrees with respect to the A-phase signal, and a Z-phase signal with one pulse per rotation. The Z-phase signal is a signal with an active level at a predetermined reference position that is determined as only one position per rotation. The A-phase signal is level-converted and pulsated by a pulsating circuit 2a, and is input as an A-phase pulse signal to a first MCU 4a and a second MCU 4b. Similarly, the B-phase signal is level converted and pulsated by a pulsating circuit 2b, and is input as a B-phase pulse signal to the first MCU 4a and the second MCU 4b. Further, the Z-phase signal is level-converted and pulsated by a pulsating circuit 2c, and is input as a Z-phase pulse signal to the second MCU 4b. The first MCU 4a is a micro controller unit that includes a phase counting counter 6a, a capture circuit 7a, and a first counter calculation unit 8, serving as peripheral equipment. Similarly, the second MCU 4b is a micro controller unit that includes a phase counting counter 6b, first and second capture circuits 7b and 7c, and a second counter calculation unit 9. Each of the phase counting counters 6a and 6b has capability of phase counting. Each of the capture circuits 7a, 7b, and 7c captures a count value of the counter based on at least two external signals. These micro controller units are available from a wide variety of products on the market. The first MCU 4a generates a first count value C1 that is not subjected to counter clearing by the Z-phase pulse signal for the count value obtained by phase-counting the A-phase pulse signal and the B-phase pulse signal, and outputs the generated first count value C1 to a safety controller 10 at every speed monitoring period. The second MCU 4b acquires, from the count value obtained by phase-counting the A-phase pulse signal and the B-phase pulse signal (hereinafter, referred to as “base count value Cb”), a single-turn count value Cs that is cleared by the Z-phase pulse signal and a multi-turn count value Cm that counts the Z-phase pulse signal. Further, the second MCU 4b outputs the single-turn count value Cs and the multi-turn count value Cm, as a second count value C2, to the safety controller 10 at every speed monitoring period. The second count value C2 can be converted into a count value of the same format as the first count value C1 by using the wave number N per rotation. The wave number N per rotation is set and stored in the safety controller 10. For example, safety communication in which measures against transmission errors are taken will be used for outputting the first count value C1 and the second count value C2 from the first MCU 4a and the second MCU 4b to the safety controller 10.

A first speed monitoring unit 11 of the safety controller 10 performs speed monitoring using a change amount ΔC1 of the first count value C1 at every speed monitoring period T and a single-turn count setting value N′ of the encoder 1, which is set beforehand in the safety controller 10, in which a first monitoring speed V1 is calculated as V1=ΔC1/N′. The single-turn count setting value N′ is a count value of the phase counting when the encoder 1 makes one complete rotation. In the case of phase counting of 4×, the single-turn count setting value N′ is given as N′=4×N using the wave number N per rotation.

Similarly, a second speed monitoring unit 12 of the safety controller 10 performs speed monitoring using a change amount ΔC2 of the second count value C2 at every speed monitoring period T and the preset single-turn count setting value N′ of the encoder 1, in which a second monitoring speed V2 is calculated as V2=ΔC2/N′. The second count value C2 is converted into a count value of the same format as that in the case where the counter clearing by the Z-phase signal is not performed, and is used for the calculation of ΔC2. This conversion is performed by applying the multi-turn count value Cm and the single-turn count value Cs to the following formula (1).

$$C 2 = ( Cm + F ) \times {N}^{′} + Cs \qquad ( 1 )$$

Here, F takes value 0 when the single-turn count value Cs is 0 or positive, and takes value 1 when it is negative. The first speed monitoring unit 11 and the second speed monitoring unit 12 mutually exchange the change amount ΔC1 of the first count value C1 and the change amount ΔC2 of the second count value C2, and if |ΔC1−ΔC2| is equal to or greater than a pre-defined abnormality detection threshold, detect an abnormality in a speed monitoring interface. The abnormality detection threshold can be set to, for example, 4 counts; i.e., a count value corresponding to 1 wave number. This makes it possible to detect an abnormality when the single-turn wave number N of the encoder 1 does not coincide with the single-turn wave number setting value N′.

The phase counting counter 6a of the first MCU 4a is a counting circuit that performs quadruple phase counting using the A-phase pulse signal and the B-phase pulse signal. The A-phase pulse signal and the B-phase pulse signal may be subjected to noise removal by noise filters 5a and 5b before being input to the phase counting counter 6a. The capture circuit 7a detects an active edge of a capture timing signal output by a capture timing generation unit 3 described below, and latches the count value of the phase counting counter 6a. The capture timing signal may be subjected to noise removal by a noise filter 5c before being input to the capture circuit 7a.

The first counter calculation unit 8 performs predetermined interrupt processing every time the capture circuit 7a latches the count value. As the interrupt processing, the first counter calculation unit 8 makes the count value latched by the capture circuit 7a conform with a bit width M′ of the first count value C1 that the safety controller 10 requires, and outputs the conformed value, as the first count value C1, to the safety controller 10 at every speed monitoring period.

The conformity of the bit width is performed by software processing. If M≥M′, the first counter calculation unit 8 extracts a lower M′ bit from the bit width M of the phase counting counter 6a. Further, in the case of M<M′, the first counter calculation unit 8 detects an overflow or underflow from a change in the count value latched by the capture circuit 7a, and increments an (M′−M) bit extended counter by +1 upon overflow and decrements it by −1 upon underflow. Although not illustrated, the first counter calculation unit 8 is a microcomputer that includes various memories, a calculation device (i.e., a processor), and the like, which are necessary to perform software processing.

The phase counting counter 6b of the second MCU 4b is a counting circuit that performs quadruple phase counting using the A-phase pulse signal and the B-phase pulse signal. The A-phase pulse signal and the B-phase pulse signal may be subjected to noise removal by noise filters 5d and 5e before being input to the phase counting counter 6b. The first capture circuit 7b detects an active edge of the capture timing signal output by the capture timing generation unit 3 and latches the count value of the phase counting counter 6b. The capture timing signal may be subjected to noise removal by a noise filter 5f before being input to the first capture circuit 7b. The second capture circuit 7c detects an active edge of the Z-phase pulse signal and latches the count value of the phase counting counter 6b. The Z-phase pulse signal may be subjected to noise removal by a noise filter 5g before being input to the second capture circuit 7c.

The second counter calculation unit 9 performs interrupt processing every time the first capture circuit 7b latches the count value. As the interrupt processing, the second counter calculation unit 9 performs software processing described below based on a position count value Cp latched by the first capture circuit 7b and a reference count value Cz latched by the second capture circuit 7c, to calculate the single-turn count value Cs and the multi-turn count value Cm. Then, the second counter calculation unit 9 outputs the single-turn count value Cs and the multi-turn count value Cm, as the second count value C2, to the safety controller 10, at every speed monitoring period. Although not illustrated, the second counter calculation unit 9 is a microcomputer that includes various memories, a calculation device (i.e., a processor), and the like, which are necessary to perform software processing.

The capture timing generation unit 3 is a circuit that generates and outputs the capture timing signal indicating a capture period Ts. The capture period Ts is a value satisfying Ts=T/INT (in which INT is a positive integer) for the speed monitoring period T. Further, the capture period Ts is a value having been set beforehand so as to be shorter than the period of the Z-phase signal when the encoder 1 rotates at the maximum rotation speed. Although the capture timing generation unit 3 is illustrated in FIG. 1 as a constituent component independent of the first MCU 4a and the second MCU 4b, it is not necessarily an independent constituent component. For example, the first MCU 4a or the second MCU 4b may be configured to output the capture timing signal.

Hereinafter, exemplary processing performed by the second counter calculation unit 9 will be described with reference to a flowchart of FIG. 2. The processing of the flowchart illustrated in FIG. 2 is started at every count latch by the first capture circuit 7b (i.e., at every capture period Ts), as described above. In the following description, Cp(n) represents a current value of the position count value Cp obtained through latching, and Cp(n−1) represents a previous value. Other parameters will be denoted in the same manner.

In step S901, the position count value Cp(n) is acquired from the first capture circuit 7b and a reference count value Cz(n) is acquired from the second capture circuit 7c, through 0 extension. In addition, previous values of the position count value Cp(n) and the reference count value Cz(n) are acquired, from the memory, as a previous position count value Cp(n−1) and a previous reference count value Cz(n−1), through 0 extension. Then, the processing proceeds to step S902.

Step S902 is correction processing for eliminating discontinuity of Cp(n), Cz(n), Cp(n−1), and Cz(n−1) caused by overflow or underflow of the phase counting counter 6b in step S903 and subsequent processing. Specifically, a corrected position count value Cp′(n), a corrected previous position count value Cp′(n−1), a corrected reference count value Cz′(n), and a corrected previous reference count value Cz′(n−1) are calculated using the following formulae. Then, the processing proceeds to step S903.

$${Cp}^{′} ( n ) = Cp ( n ) + f \times f 1 \times 2 M \\ {Cp}^{′} ( n - 1 ) = Cp ( n - 1 ) + f \times f 2 \times 2 M \\ {Cz}^{′} ( n ) = Cz ( n ) + f \times f 3 \times 2 M \\ {Cz}^{′} ( n - 1 ) = Cz ( n - 1 ) + f \times f 4 \times 2 M$$

Here, M represents a bit width of the phase counting counter 6b, and f is a flag indicating implementation of the correction processing. At least one of the above-described count values Cp(n), Cz(n), Cp(n−1), and Cz(n−1) is used in determination. If the count value used in the determination is not greater than a lower-limit threshold or not less than an upper-limit threshold, f is 1 and otherwise takes 0. Regarding the thresholds, the bit width M can be used to set the lower-limit threshold to 2M/4 and the upper-limit threshold to 2M×3/4. If Cp(n) is equal to or less than a determination value, f1 is 1 and, if greater than the determination value, takes 0. Similarly, if Cp(n−1) is equal to or less than the determination value, f2 is 1 and, if greater than the determination value, takes 0. If Cz(n) is equal to or less than the determination value, f3 is 1 and, if greater than the determination value, takes 0. If Cz(n−1) is equal to or less than the determination value, f4 is 1 and, if greater than the determination value, takes 0. When using the bit width M, the determination value can be set to 2(M−1), for example. The above-described method of setting the lower-limit threshold, the upper-limit threshold, and the determination value is a mere example and may be changed as appropriate.

Step S903 is processing using a Z-phase passing flag for determining whether the multi-turn count value Cm has been once counted up or down. If the Z-phase passing flag is OFF, then the processing proceeds to step S904. If ON, then the processing proceeds to step S911. The Z-phase passing flag is turned OFF in initialization processing (not illustrated).

Step S904 through step S910 are processing to be performed when the multi-turn count value Cm has never been counted up or down. Here, the multi-turn count value Cm is counted up or down when the reference position is regarded as having been passed by the Z-phase signal. The reference position of the Z-phase signal is determined based on logical levels of the A-phase pulse signal, the B-phase pulse signal, and the Z-phase pulse signal. For example, the reference position of the Z-phase signal is a position where, when the Z-phase pulse signal is an active H signal, the A-phase pulse signal is at an L level, the B-phase pulse signal is at an L level, and the Z-phase pulse signal is at an H level.

Step S904 is for acquiring, from the second capture circuit 7c, a status indicating whether the latch operation of the phase counting counter 6b has been performed, even once, in response to the active edge of the Z-phase pulse signal. If the latch operation has been performed, then the processing proceeds to step S905. If not, then the processing proceeds to step S910.

Steps S905 and S907 are processing for determining whether the reference position has been passed by the Z-phase signal. In the present example, when there is a large advancement larger than two counts after detection of the active edge of the Z-phase signal, the reference position is regarded as having been passed. Therefore, when a relationship Cp′(n)>Cz′(n)+2≥Cp′(n−1) is satisfied, it is determined that the reference position has been passed in the forward rotation direction. As described above, the reference count value Cz is a value obtained by latching the base count value Cb at the time when the active edge of the Z-phase signal has been detected. Accordingly, Cz′(n) is the base count value Cb when the active edge of the Z-phase signal is most recently detected.

If YES in step S905, the processing proceeds to step S906, in which a reference count correction value Zc(n) is set to +2 and the multi-turn count value Cm is set to +1. On the other hand, if NO in step S905, the processing proceeds to step S907, in which when a relationship Cp′(n)<Cz′(n)−2≤Cp′(n−1) is satisfied, it is determined that the reference position has been passed in the reverse rotation direction, and then the processing proceeds to step S908. In step S908, the reference count correction value Zc(n) is set to −2, and the multi-turn count value Cm is set to −1. Step S909 is common processing to be performed after the processing of steps S906 and S907 when the reference position is regarded as having been passed by the Z-phase signal. In step S909, the Z-phase passing flag is turned ON, and a reference count estimation value Czc is set to a value obtained by adding the reference count value Cz′(n) and the reference count correction value Zc(n).

Here, the reference count correction value Zc(n) is a correction value for correcting a difference between the base count value Cb at the active edge of the Z-phase pulse signal (i.e., reference count value Cz) and the base count value Cb at a true Z-phase reference position. Further, the reference count estimation value Czc is the base count value Cb at an estimated Z-phase reference position. As described above, the true Z-phase reference position is determined based on the logical levels of the A-phase pulse signal, the B-phase pulse signal, and the Z-phase pulse signal. For example, when the Z-phase pulse signal is an active H signal, the true Z-phase reference position is, for example, a position where the A-phase pulse signal is at an L level, the B-phase pulse signal is at an L level, and the Z-phase pulse signal is at an H level.

Step S910 is processing for clearing the reference count correction value Zc(n), the reference count estimation value Czc, and the Z-phase passing flag when the reference position is regarded as having never been passed by the Z-phase signal.

Step S911 through step S920 are processing to be performed after the reference position is regarded as having been passed, even once, by the Z-phase signal. Step S911 through step S915 are processing for updating the reference count correction value Zc(n). Specifically, when a relationship Cz′(n)−Cz′(n−1)>6 is satisfied, it is determined that the active edge of the Z-phase signal has been passed in the forward rotation direction, and Zc(n)=+2 is set. When a relationship Cz′(n)−Cz′(n−1)<−6 is satisfied, it is determined that the active edge of the Z-phase signal has been passed in the reverse rotation direction, and Zc(n)=−2 is set. In other cases, it is determined that the direction of rotation has been changed and the active edge of the Z-phase signal has been passed, or has not been passed, and Zc(n)=Zc(n−1)−Cz′(n)+Cz′(n−1) is set.

Here, Zc(n−1) is the previous value of the reference count correction value Zc(n), and the value stored in the memory is acquired. Further, the reference value “6” used in determination is the maximum value of the difference between the base count value Cb at the active edge of the Z-phase pulse signal and the base count value Cb at a non-active edge of the Z-phase pulse signal. In other words, the reference value “6” is a count value corresponding to the maximum pulse width of the Z-phase pulse signal. If the maximum width of the Z-phase pulse signal exceeds a value corresponding to 6 counts, there will be a plurality of reference positions based on the logical levels of the A-phase pulse signal, the B-phase pulse signal, and the Z-phase pulse signal, regardless of a phase relationship among the A-phase pulse signal, the B-phase pulse signal, and the Z-phase pulse signal. Therefore, the maximum width of the Z-phase pulse signal is always the value corresponding to 6 counts or less.

Step S916 is for setting the reference count estimation value Czc to a value obtained by adding the reference count value Cz′(n) and the reference count correction value Zc(n), and then the processing proceeds to S917.

Step S917 through step S920 are processing for counting up or down the multi-turn count value Cm. Specifically, when a relationship Cp′(n)≥Czc>Cp′(n−1) is satisfied, it is determined that the reference position has been passed in the forward rotation direction by the Z-phase signal, and the multi-turn count value Cm is counted up. When a relationship Cp′(n)<Czc≤Cp′(n−1) is satisfied, the multi-turn count value Cm is counted down.

Step S921 is processing for calculating the single-turn count value Cs, in which the single-turn count value is set to a value obtained by subtracting Czc from Cp′(n).

Step S922 is for storing the position count value Cp(n), the reference count value Cz(n), and the reference count correction value Zc(n), as previous values, in the memory so that these values can be referred to when the next processing is started.

Here, as described above, the safety controller 10 determines whether there is a speed abnormality, based on the difference amount between the change amount ΔC1 of the first count value C1 and the change amount ΔC2 of the second count value C2; i.e., |ΔC1-ΔC2|. When the base count value Cb at the true Z-phase reference position is a “true reference count value Cz*”, the difference amount |ΔC1-ΔC2| is equal to a value obtained by adding an amount of change in an error ΔCz=|Czc-Cz*| between the reference count estimation value Czc and the true reference count value Cz* and a difference +1 between the count values captured by the capture circuit 7a and the first capture circuit 7b. The difference in the capture value occurs, for example, due to a difference in delay time between internal signals of the first MCU 4a and the second MCU 4b.

The error ΔCz is determined depending on the reference count correction value Zc(n) and the pulse width of the Z-phase pulse signal. That is, the difference between the base count value Cb at the time when the active edge of the Z-phase pulse signal has been passed in the forward rotation direction (i.e., reference count value Cz) and the base count value Cb at the true Z-phase reference position (i.e., true reference count value Cz*) is set to w1, and the difference between the reference count value Cz at the timing of having been passed in the reverse rotation direction and the true reference count value Cz* is set to −w2. In this case, the error ΔCz at the time when the active edge of the Z-phase pulse signal has been passed in the forward rotation direction is w1−2. In addition, the error ΔCz at the time when the active edge of the Z-phase pulse signal has been passed in the reverse rotation direction is −w2+2. Accordingly, when w=w1+w2, the amount of change in ΔCz is |w−4| at most, as shown in formula 2.

$$\vert Amount of change in Δ Cz \vert = \vert ( w 1 - 2 ) - ( - w 2 + 2 ) \vert = \vert w - 4 \vert \qquad ( 2 )$$

Here, w=w1+w2 is a value obtained by converting the pulse width at the active level of the Z-phase pulse signal into the count value of the phase counting counter 6b. As described above, the maximum value of w is 6. The minimum value of w is 2, under the condition of including logical level ranges of the A-phase pulse signal and the B-phase pulse signal where the active level of the Z-phase pulse signal is the true Z-phase reference position. Accordingly, from formula (2), the amount of change in ΔCz at the speed monitoring period Ts falls within a range of +2. Thus, the difference between ΔC1 being the amount of change in the first count value C1 and ΔC2 being the amount of change in the second count value C2 falls within a range of ±3.

As a result, configuring the second counter calculation unit 9 so as to perform the above-described processing illustrated in FIG. 2 makes it possible to suppress the difference between ΔC1 being the amount of change in the first count value C1 and ΔC2 being the amount of change in the second count value C2, at the speed monitoring period Ts, to be equal to or less than 4 counts, which is less than the equivalent of one wave number. Thus, the safety controller 10 can perform speed monitoring without erroneously detecting an abnormality in the speed monitoring interface.

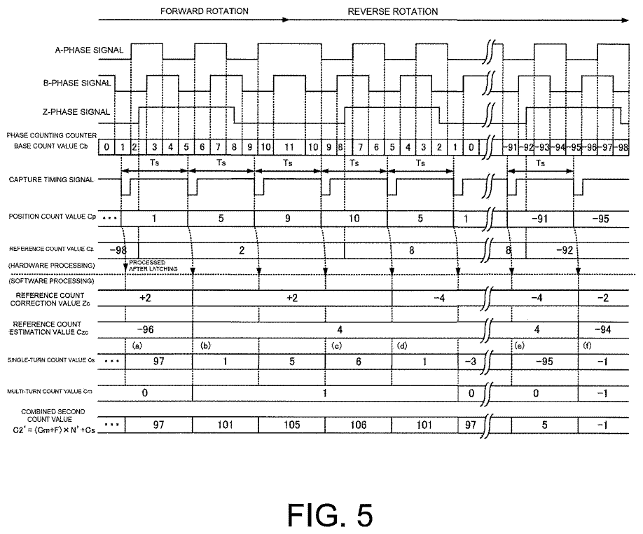

For example, FIG. 5 is an exemplary timing chart illustrating exemplary passing of the Z-phase signal in the order of

[1] forward rotation direction, two or more times (not illustrated)

[2] forward rotation direction (between (a) and (b) in FIG. 5)

[3] reverse rotation direction (between (c) and (d) in FIG. 5)

[4] reverse rotation direction (between (e) and (f) in FIG. 5) when the wave number N=25 and the Z-phase signal pulse width is equivalent to 6 counts.

In FIG. 5, in order to make the timing chart easier to understand, the correction processing (0 extension in step S901 and step S902) considering the overflow and underflow in the flowchart of FIG. 2 is omitted. The Z-phase signal passing in [2] is a Z-phase signal passing when the forward rotation continues, and the reference count correction value Zc is held at +2 by the processing of step S912 in FIG. 2. Therefore, no error occurs in count value difference. The Z-phase signal passing in [3] is a first Z-phase signal passing after transition from forward rotation to reverse rotation, and the reference count correction value Zc is corrected by an amount of the pulse width of the Z-phase signal by the processing of step S915 in FIG. 2. Therefore, the reference count estimation value Czc is the same value as that at the time of Z-phase signal passing in the immediately previous forward rotation direction ([2]). Therefore, no error occurs in count value difference. The Z-phase signal passing in [4] is a second Z-phase signal passing after transition from forward rotation to reverse rotation, and the reference count correction value is set to −2 by the processing of step S914 in FIG. 2. At this time, the difference in phase counting counter is −4 between (e) and (f) in FIG. 5. On the other hand, the count value difference after the single-turn count value Cs and the multi-turn count value Cm are converted using the formula (1) becomes −6. As a result, an error of −2 occurs. In FIG. 5, the pulse width of the Z-phase signal is equivalent to 6 counts, which coincides with the calculation result using the formula (2).

### REFERENCE SIGNS LIST

1 encoder
2a, 2b, 2c: pulsating circuit
3: capture timing generation unit
4a: first MCU
4b: second MCU
5a, 5b, 5c, 5d, 5e, 5f, 5g: noise filter
6a, 6b: phase counting counter
7a: capture circuit
7b: first capture circuit
7c: second capture circuit
8: first counter calculation unit
9: second counter calculation unit
10: safety controller
11: first speed monitoring unit
12: second speed monitoring unit

1. A rotation speed monitoring device for monitoring the rotation speed of an object, comprising:
an encoder that outputs an A-phase signal of N pulses per rotation, a B-phase signal that is 90 degrees out of phase with respect to the A-phase signal, and a Z-phase signal of 1 pulse per rotation;
a first unit configured to output a first count value by quadruple phase counting based on the A-phase signal and the B-phase signal;
a second unit configured to calculate a second count value consisting of a within-single-turn count value obtained by counter-clearing, by the Z-phase signal, the count value obtained by the quadruple phase counting based on the A-phase signal and the B-phase signal, and a multi-turn count value obtained by counting up or down the Z-phase signal according to the direction of rotation; and
a safety controller that calculates a first monitoring speed based on an amount of change in the first count value, calculates a second monitoring speed based on an amount of change in the second count value, and determines whether there is a speed abnormality based on a result of comparison between the first monitoring speed and the second monitoring speed,
wherein the second unit includes:
a phase counting counter that performs quadruple phase counting of the A-phase signal and the B-phase signal, and outputs the counted result as a base count value;
a first capture circuit that latches the base count value at a capture period being a value obtained by dividing a speed monitoring period by a positive integer, and outputs the latched value as a position count value;
a second capture circuit that latches the base count value at an active edge of the Z-phase signal and outputs the latched value as a reference count value; and
a second counter calculation unit configured to calculate the second count value based on the position count value and the reference count value,
wherein the second counter calculation unit calculates a reference count correction value corresponding to a difference between the base count value and the reference count value at a reference position of the Z-phase signal, based on a current value of the reference count value, a previous value of the reference count value, and a previous value of the reference count correction value,
calculates a reference count estimation value by adding the reference count correction value to the reference count value,
counts up or down the multi-turn count value based on a magnitude relationship between a current value of the position count value, a previous value of the position count value, and the reference count estimation value, and
calculates a difference value between the position count value and the reference count estimation value as the within-single-turn count.

2. The speed monitoring device according to claim 1, wherein
the second counter calculation unit calculates a difference value between the current value of the reference count value and the previous value of the reference count value while taking overflow and underflow into consideration, sets the reference count correction value to +2 when the difference value exceeds a count value corresponding to a pulse width of the Z-phase signal, sets the reference count correction value to −2 when the difference value falls below the inverse of the count value equivalent to the pulse width of the Z-phase signal, and otherwise sets the reference count correction value to a value obtained by subtracting a difference value between the current value of the reference count value and the previous value of the reference count value from the previous value of the reference count correction value.

3. The speed monitoring device according to claim 1, wherein the second counter calculation unit sets each of the reference count correction value and the multi-turn count value to 0, after acquiring an initial value of the reference count value, until either a first condition or a second condition is satisfied, sets the reference count correction value to +2 and sets the multi-turn count value to +1, when the first condition is satisfied, and sets the reference count correction value to −2 and sets the multi-turn count value to −1, when the second condition is satisfied, and further when the reference count value is Cz(n), the current value of the position count value is Cp(n), and the previous value of the position count value is Cp(n−1), and the values after correction processing for eliminating discontinuity of Cz(n), Cp(n), and Cp(n−1) are Cz′(n), Cp′(n), and Cp′(n−1), respectively, the first condition is Cp′(n)>Cz′(n)+2≥Cp′(n−1) and the second condition is Cp′(n)<Cz′(n)−2≤Cp′(n−1).
